(19) United States
(12) Patent Application Publication
(10) Pub. No.: US 2026/0066714 A1
(43) Pub. Date: Mar. 5, 2026

(54) COUPLING ESTIMATION IN WIRELESS CHARGING SYSTEMS

(71) Applicant: Apple Inc., Cupertino, CA (US)

(72) Inventors: Zaid A. AbuKhalaf, Sunnyvale, CA (US); Alin I. Gherghescu, Campbell, CA (US); Gerard B. Kato, San Jose, CA (US)

(21) Appl. No.: 19/280,463

(22) Filed: Jul. 25, 2025

Related U.S. Application Data
(60) Provisional application No. 63/688,977, filed on Aug. 30, 2024.

(51) Int. Cl. H02J 50/90; H02J 50/10; H02J 50/80

(52) U.S. Cl. CPC H02J 50/90; H02J 50/10; H02J 50/80

(57) ABSTRACT

Handling k-estimation errors in a wireless power transfer system can include performing k-estimation during a digital ping phase of a wireless power transfer negotiation; determining that an error occurred while performing k-estimation; determining whether the wireless power receiver is available to assist in correcting the error; responsive to determining that an error occurred while performing k-estimation and the wireless power receiver being available to assist in correcting the error, performing a full mode error correction procedure in which the wireless power transmitter cooperates with the wireless power receiver to correct the error that occurred during k-estimation; and responsive to determining that an error occurred while performing k-estimation and the wireless power receiver being unavailable to assist in correcting the error, performing a restricted mode error correction procedure in which the wireless power transmitter attempts to correct the error that occurred during the k-estimation without cooperation from the wireless power receiver.

### BACKGROUND

Wireless power transfer is used in various electronic devices. For example, smart phones, tablet computers, smart watches, wireless earphones, styluses, etc. may employ wireless power transfer to facilitate charging of batteries within the devices and/or to power the devices during operation.

### SUMMARY

A method of handling k-estimation errors in a wireless power transfer system including a wireless power transmitter and a wireless power receiver can be performed by the wireless power transmitter and can include performing k-estimation during a digital ping phase of a wireless power transfer negotiation; determining that an error occurred while performing k-estimation; determining whether the wireless power receiver is available to assist in correcting the error; responsive to determining that an error occurred while performing k-estimation and the wireless power receiver being available to assist in correcting the error, performing a full mode error correction procedure in which the wireless power transmitter cooperates with the wireless power receiver to correct the error that occurred during k-estimation; and responsive to determining that an error occurred while performing k-estimation and the wireless power receiver being unavailable to assist in correcting the error, performing a restricted mode error correction procedure in which the wireless power transmitter attempts to correct the error that occurred during the k-estimation without cooperation from the wireless power receiver.

Determining that an error occurred while performing k-estimation can be based on the wireless power receiver sending an extended identification packet with a restricted field therein set to 1 for restricted mode.

Performing a restricted mode error correction procedure can further include removing the power signal, resetting the wireless power link; performing one or more corrective actions; and initiating a further digital ping phase. The one or more corrective actions can include initiating a further digital ping at a second voltage level different from a first voltage level of the digital ping. Performing a full mode error correction procedure can further include entering a negotiation phase with error; and communicating the error to the wireless power receiver. Communicating the error to the wireless power receiver can include sending a not acknowledged (NAK) packet responsive to a configuration (CFG) packet from the PRx; sending an error (ERR) packet responsive to a GET packet from the wireless power receiver.

Performing a full mode error correction procedure can further include responsive to receiving from the wireless power receiver, information allowing the error to be cleared, completing the wireless power transfer negotiation phase; and responsive to not receiving, from the wireless power receiver, information allowing the error to be cleared: receiving a request from the wireless power receiver to exit the negotiation phase; removing the power signal, resetting the wireless power link; performing one or more corrective actions; and initiating a further digital ping phase. Additional information received from the wireless power receiver can include ecosystem scaling coefficients. The ecosystem scaling coefficients can be received in an ecosystem scaling coefficient packet. The information allowing the error to be cleared can be included in an EPT/rst packet from the wireless power receiver.

A wireless power transmitter can include control and communication circuitry that performs k-estimation during a digital ping phase of a wireless power transfer negotiation; determines that an error occurred while performing k-estimation; determines whether the wireless power receiver is available to assist in correcting the error; responsive to determining that an error occurred while performing k-estimation and the wireless power receiver being available to assist in correcting the error, performs a full mode error correction procedure in which the wireless power transmitter cooperates with the wireless power receiver to correct the error that occurred during k-estimation. The full mode error correction procedure can include entering a negotiation phase with error; and communicating the error to the wireless power receiver. Alternatively, responsive to determining that an error occurred while performing k-estimation and the wireless power receiver being unavailable to assist in correcting the error, the transmitter control circuitry can perform a restricted mode error correction procedure in which the wireless power transmitter attempts to correct the error that occurred during the k-estimation without cooperation from the wireless power receiver. The restricted mode error correction procedure can include removing the power signal, resetting the wireless power link; performing one or more corrective actions; and initiating a further digital ping phase.

Determining that an error occurred while performing k-estimation can be based on receiving from a wireless power receiver an extended identification packet with a restricted field therein set to 1 for restricted mode. The one or more corrective actions can include the control and communication circuitry initiating a further digital ping at a second voltage level different from a first voltage level of the digital ping. Communicating the error to the wireless power receiver can include the control and communication circuitry sending a not acknowledged (NAK) packet responsive to a configuration (CFG) packet from the PRx; and sending an error (ERR) packet responsive to a GET packet from the wireless power receiver. Performing a full mode error correction procedure can further include responsive to receiving from the wireless power receiver, information allowing the error to be cleared, completing the wireless power transfer negotiation phase, wherein the information allowing the error to be cleared is included in an EPT/rst packet from the wireless power receiver received by the control and communication circuitry; and responsive to not receiving, from the wireless power receiver, information allowing the error to be cleared: receiving a request from the wireless power receiver to exit the negotiation phase; removing the power signal, resetting the wireless power link; performing one or more corrective actions; and initiating a further digital ping phase. Additional information received from the wireless power receiver can include ecosystem scaling coefficients received in an ecosystem scaling coefficient packet.

A method of handling k-estimation errors in a wireless power transfer system including a wireless power transmitter and a wireless power receiver can be performed by the wireless power receiver and can include receiving from the wireless power transmitter an indication that an error has occurred during a digital ping phase; receiving from the wireless power transmitter an indicated cause of the error in the digital ping phase; responsive to the indicated cause being k-estimation error and correctable by the wireless power receiver, transmitting additional information to the wireless power transmitter, thereby cooperating with the wireless power transmitter to resolve the error; and responsive to the indicated cause not being correctable by the wireless power receiver, transmitting a reset message to the wireless power transmitter, thereby causing the wireless power transmitter to attempt to resolve the error on its own.

The additional information can include an extended identification packet with a restricted field therein set to 1 for restricted mode. Transmitting additional information to the wireless power transmitter, thereby cooperating with the wireless power transmitter to resolve the error, can include transmitting ecosystem scaling coefficients in an ecosystem scaling coefficient packet. The reset message can include an EPT/rst packet.

A wireless power receiver can include control and communication circuitry that receives from the wireless power transmitter an indication that an error has occurred during a digital ping phase; receives from the wireless power transmitter an indicated cause of the error in the digital ping phase; responsive to the indicated cause being k-estimation error and correctable by the wireless power receiver, transmits additional information to the wireless power transmitter, thereby cooperating with the wireless power transmitter to resolve the error; and responsive to the indicated cause not being correctable by the wireless power receiver, transmits a reset message to the wireless power transmitter, thereby causing the wireless power transmitter to attempt to resolve the error on its own.

The additional information can include an extended identification packet with a restricted field therein set to 1 for restricted mode. The additional information can include transmitting ecosystem scaling coefficients in an ecosystem scaling coefficient packet. The reset message can include an EPT/rst packet.

### BRIEF DESCRIPTION OF THE DRAWINGS

FIG. 1 illustrates a simplified block diagram of a wireless power transfer system.

FIG. 2 illustrates a flow chart of a technique for handling errors in a k-estimation process of a wireless power transfer system.

FIG. 3 illustrates a table of potential k-estimation error sources and solutions.

FIG. 4 illustrates an example communication flow between a PTx and a PRx using a k-estimation error handling process in a restricted mode.

FIG. 5 illustrates an example communication flow between a PTx and a PRx using a k-estimation error handling process in a first scenario of a full mode.

FIG. 6 illustrates an example communication flow between a PTx and a PRx using a k-estimation error handling process in a second scenario of a full mode.

FIG. 7 illustrates an example data packet structure for exchanging ecosystem scaling coefficients between a PTx and a PRx.

FIG. 8 illustrates an example data packet structure for exchanging error information between a PTx and a PRx.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose. Any trademarks referenced herein are intended to only to identify examples and are property of their respective owners.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

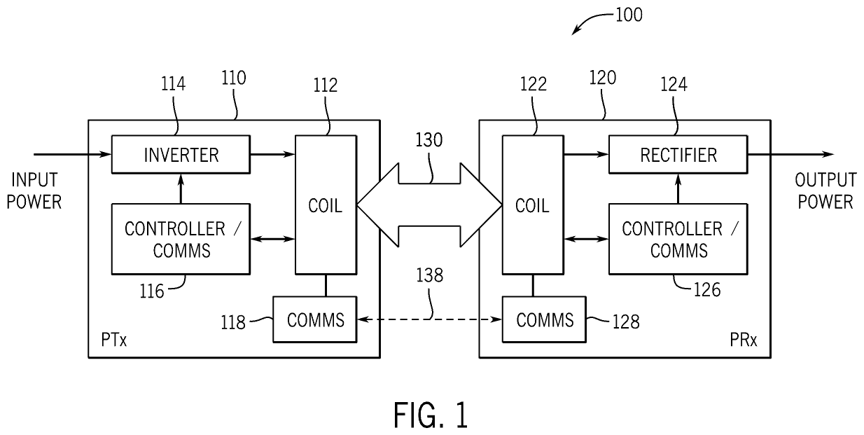

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

In wireless power transfer applications, a PTx may estimate or calculate a coupling coefficient (denoted “k”) between the PTx and a PRx. The coupling coefficient k is a magnetic circuit property that depends at least in part on the relative positions/alignment between the PTx and the PRx coils and can be used to estimate or calculate a maximum amount of power that the PTx can deliver to the PRx. The k estimation can be performed by the PTx, e.g., by controller and communication circuitry of the PTx as described above, as part of a “digital ping” occurring at the beginning of the power transfer process. In some cases, examples of which are discussed in greater detail below, the k estimation procedure may be subject to errors. It may be desirable for the PTx and/or PRx to correct the cause of such errors to allow for a more accurate k estimation, which can provide for a better wireless power transfer experience.

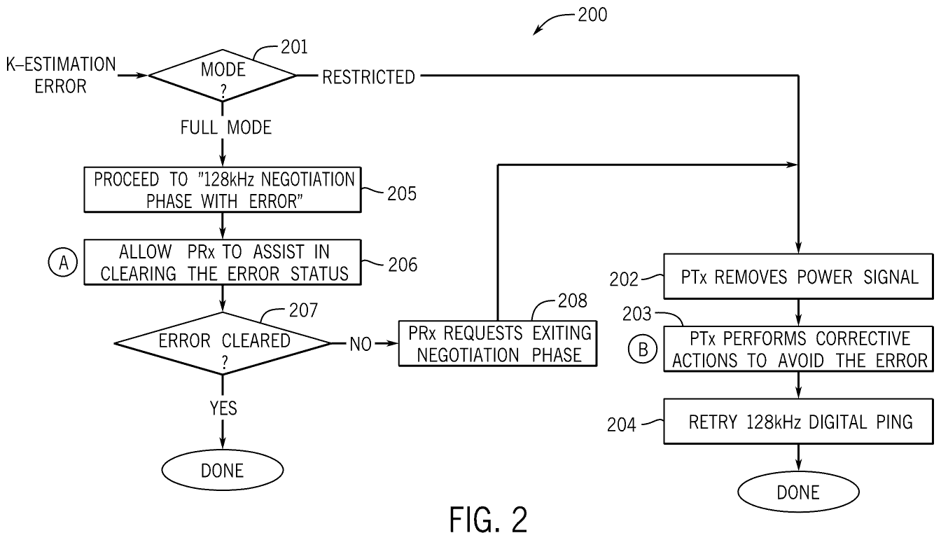

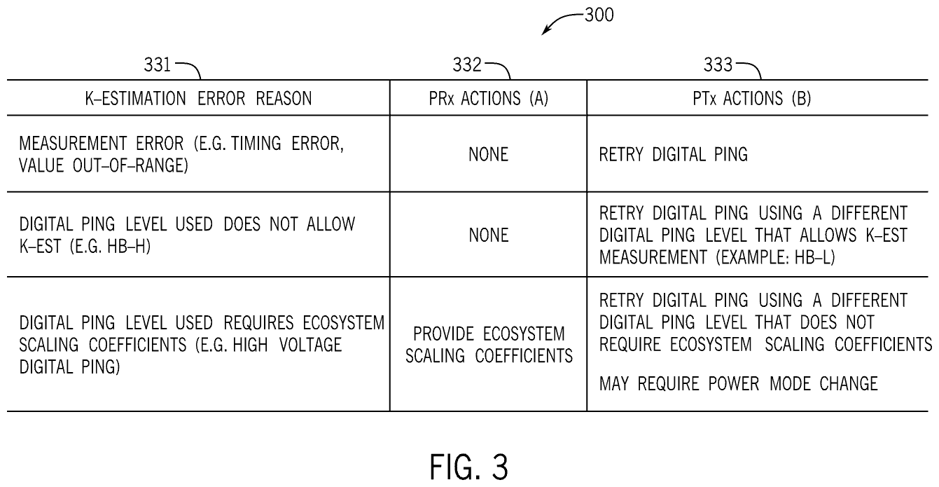

FIG. 2 illustrates a flow chart 200 of a technique for handling errors in a k-estimation process of a wireless power transfer system including a PTx and a PRx as described above with reference to FIG. 1. The process may be used as part of establishing wireless power transfer according to a standard protocol, such as the Qi wireless power transfer standards promulgated by the wireless power consortium, or according to a proprietary wireless power transfer protocol. The techniques described herein are described with reference to Qi wireless power transfer standards, but equivalent or corresponding features of a proprietary protocol may be substituted in certain applications. As part of the PTx estimating k, e.g., at the “digital ping” phase of wireless power transfer initiation, an error may occur. Examples of such errors are discussed in greater detail below with reference to FIG. 3. In any case, in block 201, the PTx can determine the “mode” for the k-estimation error handling process. A first mode, described herein as a “restricted” mode can apply to cases in which the PRx is unable to assist with resolution of error condition. As one example, this may be because the PRx device has a fully depleted battery and is therefore not fully operational at the time wireless power transfer is to be initiated. Other causes of such a condition are also possible. In any case, in the restricted mode, the PTx will attempt to resolve the error condition on its own, as described in greater detail below and depicted on the right-hand side of flow chart 200. A second mode, described herein as a “full” mode can apply to cases in which the PRx is potentially able to assist with resolution of error condition. In any case, in the full mode, the PTx will communicate with the PRx as described in greater detail below in an attempt to resolve the error condition. In some cases, this cooperation may resolve the error condition, which is depicted on the left-had side of flow chart 200. Otherwise, in some cases, the cooperation between PTx and PRx may not succeed in resolving the error condition, in which case the PTx can transition to operations similar to the restricted mode, as discussed in greater detail below.

Returning to block 201 of flowchart 200, if the PTx determines that the PRx is unable to assist in resolving the error condition resulting in the k-estimation error, then the PTx can remove the power signal (block 202) effectively resetting the wireless power link. Then, in block 203 the PTx can perform one or more corrective actions in an attempt to correct the error condition. Examples of these activities (denoted with “B”) in FIGS. 2 and 3 are discussed in greater detail below. After attempting to correct the error condition the PTx can retry the digital ping (block 204), including making another k-estimation attempt. If the subsequent k-estimation is completed successfully, wireless power transfer may proceed normally according to the standard or proprietary protocol. Otherwise, if an error condition still exists, the process of FIG. 2 can repeat attempting to resolve the new or continuing error condition. As depicted in block 204 of FIG. 2, the digital ping is described as occurring at a frequency of 128 kHz, which corresponds with at least some versions of the Qi wireless power transfer standards. However, the digital ping could take place at any other suitable frequency in accordance with an appropriate standard or proprietary protocol, and thus the techniques described herein should not be understood as being limited to any particular operating frequency.

Returning again to block 201 of flowchart 200, if the PTx determines that the PRx may be able to assist in resolving the error condition resulting in the K-estimation error, then the PTx can proceed to a “Negotiation Phase with Error” in block 205. For example, this determination can be based on the PRx transmitting its XID (extended identification) packet and setting the Restricted field in the XID packet to 1 for restricted mode. As depicted in block 205 of FIG. 2, the negotiation phase with error is described as occurring at a frequency of 128 kHz, which corresponds with at least some versions of the Qi wireless power transfer standards. However, the negotiation phase with error could take place at any other suitable frequency in accordance with an appropriate standard or proprietary protocol, and thus the techniques described herein should not be understood as being limited to any particular operating frequency. In any case, the PTx can then communicate with the PRx to negotiate a wireless power transfer link, which can include communications requesting the PRx to assist in clearing the error (block 206). Examples of these activities (denoted with “A”) in FIGS. 2 and 3 are discussed in greater detail below. These and other activities described herein as being performed by the PRx can be performed by the control and communication circuitry of the PRx as described above with reference to FIG. 1. Then, in block 207, the PTx and/or PRx can determine whether the error condition has been cleared. If so, then the power transfer negotiation and wireless power transfer can proceed normally. Otherwise, if cooperation between PTx and PRx was unsuccessful in clearing the error condition, the PRx can request an exit of the negotiation phase (block 208), and the PTx can proceed as described above with respect to the restricted mode, beginning with the PTx removing the power signal (block 202) resetting the wireless power transfer link, and otherwise proceeding as in the restricted mode described above.

FIG. 3 illustrates a table 300 of potential k-estimation error sources and solutions. The first column 331 of table 300 lists example reasons for a k-estimation error. This listing is not exhaustive, and other potential reasons could exist. The second column 332 of table 300 lists potential actions that the PRx can take to assist in resolving the error condition (denoted with an “A” corresponding to block 206 of FIG. 2, discussed above). For some error conditions, there may be no action that the PRx can take to resolve the error. The third column 333 of table 300 lists potential actions that the PTx can take to resolve the error condition, either in cooperation with the PRx or on its own.

As illustrated by the first row of table 300, a k-estimation error can be caused by a measurement error. This can be a timing error or an unexpected out of range value being measured by the PTx during the k-estimation phase of the digital ping or other k-estimation phase. In this case, there is no action that the PRx can take to resolve the condition, and the PTx action is to retry the digital ping, which would result in a transition through block 208 as described above with reference to FIG. 2.

As illustrated by the second row of table 300, a k-estimation error can be caused by using a digital ping level that does not allow for k-estimation. That is, in different wireless power transfer embodiments, different voltage levels may be used for a digital ping. As one example, a half bridge low voltage (denoted HB_L in the figures of the present application) of about 11.5, corresponding to the inverter voltage applied to the wireless power transmitting coil by the PTx, may be used, and the PTx may be configured to use such voltage with a k-estimation technique. Alternatively, a half bridge high voltage (denoted HB_H in the figures of the present application) of about 13V, corresponding to the inverter voltage applied to the wireless power transmitting coil by the PTx, may be used, and the PTx may not be configured to use such voltage with a k-estimation technique. In this case, there is nothing that the PRx can do to resolve the error condition, and the PTx action is to change to a different digital ping level (e.g., HB_L) that allows k-estimation and retry the digital ping, which would result in a transition through block 208 as described above with reference to FIG. 2.

As illustrated by the third row of table 300, a k-estimation error can be caused by a digital ping level that requires ecosystem scaling coefficients to be provided to the PTx by the PRx. For example, the PTx can have the required information, such as scaling coefficients, about a PRx to perform successful k-estimation at one digital ping voltage, e.g., HB_L, while not having the required information about the PRx to perform successful k-estimation at another digital ping voltage, e.g., HB_H. The same situation could apply to digital pings performed at different frequencies, etc. In any case, if the PRx device is able to provide the scaling coefficients to the PTx, then the PRx can assist in clearing the k-estimation error by providing such coefficients to the PTx. Then, the PTx can retry the digital ping with the newly received ecosystem scaling coefficients and/or at a different digital ping voltage (or frequency, etc.), which might include a power mode change.

Ecosystem scaling allows for a PTx and a PRx to determine various electrical and magnetic parameters of the wireless power transfer link by exchanging coefficients that allow conversion of measured properties as between the specific two devices to match a model determined with respect to a corresponding reference device. Details of ecosystem scaling systems and parameters are beyond the scope of the present disclosure, but examples may be found in Applicant's co-pending U.S. Patent Application Ser. No. 17/681,363, entitled “Wireless Power Systems with Shared Inductive-Loss Scaling Factors,” filed Feb. 25, 2022.

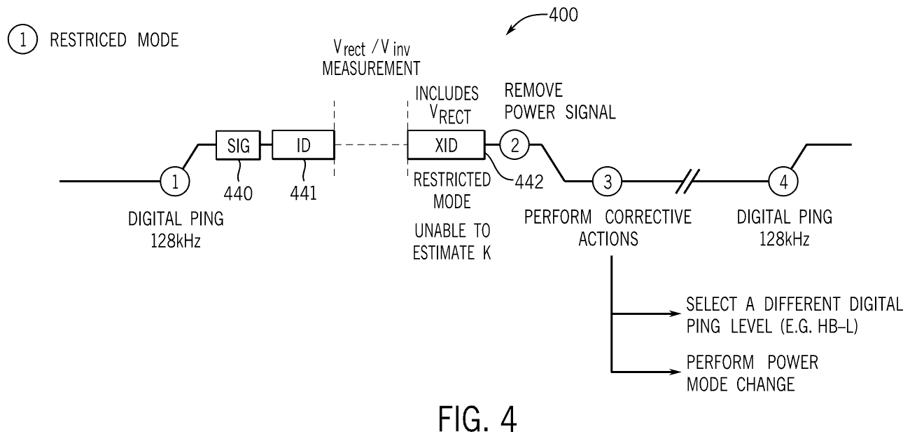

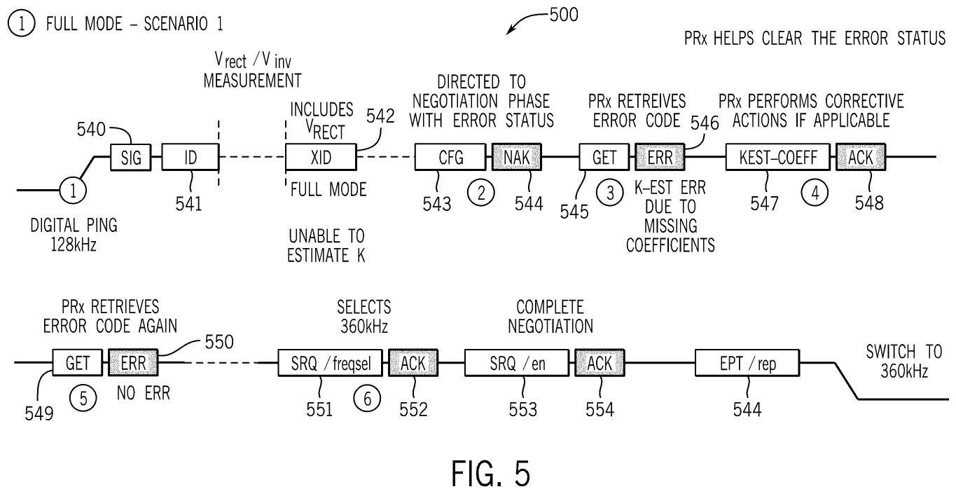

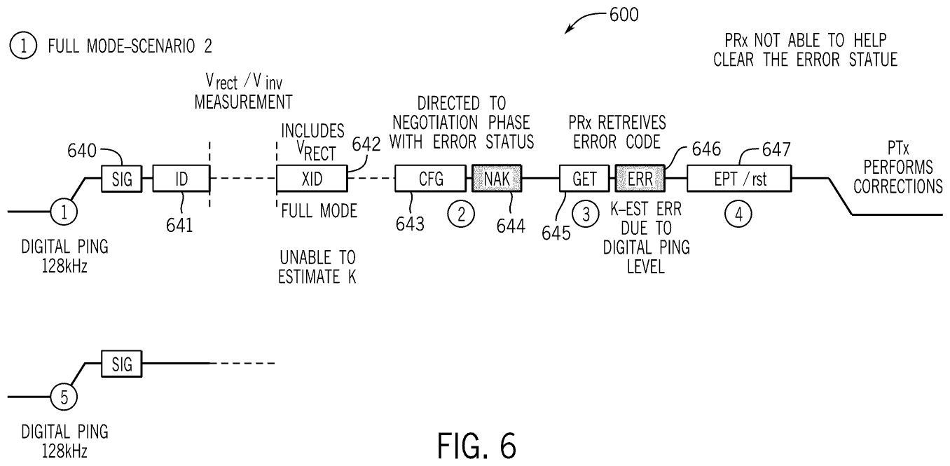

FIG. 4 illustrates an example communication flow 400 between a PTx and a PRx using a k-estimation error handling process in a restricted mode, as described above with reference to FIG. 2. As noted above, the restricted mode can be used with the PRx is unable to assist with resolving a k-estimation error condition. Throughout FIG. 4 (and subsequent FIGS. 5 and 6), messages or packets sent from PRx to PTx are denoted in white, and messages or packets sent from PTx to PRx are denoted in black. At 1, a digital ping process may be initiated by the PTx, which can result in the PRx providing one or more initial messages 440, 441. In accordance with at least some versions of the Qi standard, this can include a signal strength (SIG) packet and an identification (ID) packet. This can also trigger a measurement of Vrect (the output voltage of the rectifier described above with reference to FIG. 1) by the PRx and a measurement of Vinv (the inverter voltage applied to the wireless power transmitter coil by the PTx). Thereafter, the PRx can send an extended identification (XID) packet 442 to the PTx, which can contain the measured Vrect value. The PTx can then use this Vrect value received from the PRx together with the Vinv value measured by the PTx to compute a voltage conversion gain and a corresponding estimate of the coupling factor k.

If the PTx determines that it is unable to estimate k, which could be for one of the reasons discussed above with reference to FIG. 3 or for other reasons, it can remove the power signal at 2 (see also block 202 of FIG. 2), perform one or more corrective actions at 3 (see also block 203 of FIG. 2). This can include selecting a different digital ping level, a power mode change, etc. Then, at 4, the PTx can reinitiate the digital ping, which can result in continued operation in the restricted mode or a transition to the full mode, described in greater detail below.

FIG. 5 illustrates an example communication flow 500 between a PTx and a PRx using a k-estimation error handling process in a first scenario of a full mode, in which the PRx is able to help with resolving the error condition, as was described above with reference to FIG. 2. Throughout FIG. 5 (and subsequent FIG. 6), messages or packets sent from PRx to PTx are denoted in white, and messages or packets sent from PTx to PRx are denoted in black. At 1, a digital ping process may be initiated by the PTx, which can result in the PRx providing one or more initial messages 540, 541. In accordance with at least some versions of the Qi standard, this can include a signal strength (SIG) packet and an identification (ID) packet. This can also trigger a measurement of Vrect (the output voltage of the rectifier described above with reference to FIG. 1) by the PRx and a measurement of Vinv (the inverter voltage applied to the wireless power transmitter coil by the PTx). Thereafter, the PRx can send an extended identification (XID) packet 542 to the PTx, which can contain the measured Vrect value. The PTx can then use this Vrect value received from the PRx together with the Vinv value measured by the PTx to compute a voltage conversion gain and a corresponding estimate of the coupling factor k.

If the PTx determines that it is unable to estimate k, which could be for one of the reasons discussed above with reference to FIG. 3 or for other reasons, it can, at 2, respond to a subsequent configuration (CFG) packet 543 from the PRx with a not acknowledged (NAK) packet 544 triggering a “negotiation with error” phase as described above with reference to block 205 of FIG. 2. Thereafter, at 3, the PRx can send a get (GET) packet 545 requesting the error code from the PTx, which the PTx can provide in an error (ERR) packet 546, an example of which is described below. As one example, the error packet 546 may indicate that the k-estimation error was due to missing ecosystem scaling coefficients. Then, at 4, the PRx can send a k-estimation coefficient (KEST-COEFF) packet 547 to the PTx, which can be the PRx contribution to clearing the error condition. Then the PTx can send an acknowledgement (ACK) packet 548, indicating receipt of the coefficients, or otherwise acknowledging the PRx contribution to clearing the error condition.

Then at 5, the PRx can send a further get (GET) packet 549, requesting any further error codes. The PTx can then send a responsive error (ERR) packet 550, either indicating any additional or further error conditions or indicating that no error conditions exist. If no additional or further error condition exists, at 6 the PRx can send a frequency selection (SRQ/freqsel) packet 551 initiating a transition to operation at a different frequency, e.g., 360 kHz. This can be acknowledged by the PTx sending an acknowledgement (ACK) packet 552. Thereafter, the PRx can send a negotiation completed packet (SRQ/en) packet 553, which can also be acknowledged by the PTx (554), with the PRx then sending an EPT re-ping packet (EPT/rep) 555 followed by the optional transition to the new operating frequency. This frequency transition is optional and/or may be performed in accordance with some versions of a standard or proprietary protocol. In other embodiments or applications, operation may continue at the original frequency, which can be, but need not be, 128 kHz. In such cases, the PRx and PTx can otherwise complete the negotiation process for wireless power transfer operation with any desired parameters of frequency, voltage, power level, etc.

FIG. 6 illustrates an example communication flow between a PTx and a PRx using a k-estimation error handling process in a second scenario of a full mode, in which the PRx is not able to help with resolving the error condition, as was described above with reference to FIG. 2. Throughout FIG. 6, messages or packets sent from PRx to PTx are denoted in white, and messages or packets sent from PTx to PRx are denoted in black. At 1, a digital ping process may be initiated by the PTx, which can result in the PRx providing one or more initial messages 640, 641. In accordance with at least some versions of the Qi standard, this can include a signal strength (SIG) packet and an identification (ID) packet. This can also trigger a measurement of Vrect (the output voltage of the rectifier described above with reference to FIG. 1) by the PRx and a measurement of Vinv (the inverter voltage applied to the wireless power transmitter coil by the PTx). Thereafter, the PRx can send an extended identification (XID) packet 642 to the PTx, which can contain the measured Vrect value. The PTx can then use this Vrect value received from the PRx together with the Vinv value measured by the PTx to compute a voltage conversion gain and a corresponding estimate of the coupling factor k.

If the PTx determines that it is unable to estimate k, which could be for one of the reasons discussed above with reference to FIG. 3 or for other reasons, it can, at 2, respond to a subsequent configuration (CFG) packet 643 from the PRx with a not acknowledged (NAK) packet 644 triggering a “negotiation with error” phase as described above with reference to block 205 of FIG. 2. Thereafter, at 3, the PRx can send a get (GET) packet 645 requesting the error code from the PTx, which the PTx can provide in an error (ERR) packet 646, an example of which is described below. As one example, the error packet 646 may indicate that the k-estimation error was due to the digital ping level. Upon receiving this error packet, the PRx can determine that it is unable to assist with correcting this error, and thus, at 4, the PRx can send an EPT-reset (EPT/rst) packet 647 to the PTx, which can cause exiting the negotiation phase and further allow the PTx to attempt to resolve the k-estimation error on its own, as was described above. This can then be followed at 5 by a further digital ping technique, resulting in a repeat of the k-estimation, etc.

Then at 5, the PRx can send a further get (GET) packet 549, requesting any further error codes. The PTx can then send a responsive error (ERR) packet 550, either indicating any additional or further error conditions, potentially providing information allowing the error to be cleared, or indicating that no error conditions exist. If no additional or further error condition exists, at 6 the PRx can send a frequency selection (SRQ/freqsel) packet 551 initiating a transition to operation at a different frequency, e.g., 360 kHz. This can be acknowledged by the PTx sending an acknowledgement (ACK) packet 552. Thereafter, the PRx can send a negotiation completed packet (SQQ/en) packet 553, which can also be acknowledged by the PTx (554), with the PRx then sending an EPT re-ping packet (EPT/rep) 555 followed by the optional transition to the new operating frequency. This frequency transition is optional and/or may be performed in accordance with some versions of a standard or proprietary protocol. In other embodiments or applications, operation may continue at the original frequency, which can be, but need not be, 128 kHz. In such cases, the PRx and PTx can otherwise complete the negotiation process for wireless power transfer operation with any desired parameters of frequency, voltage, power level, etc.

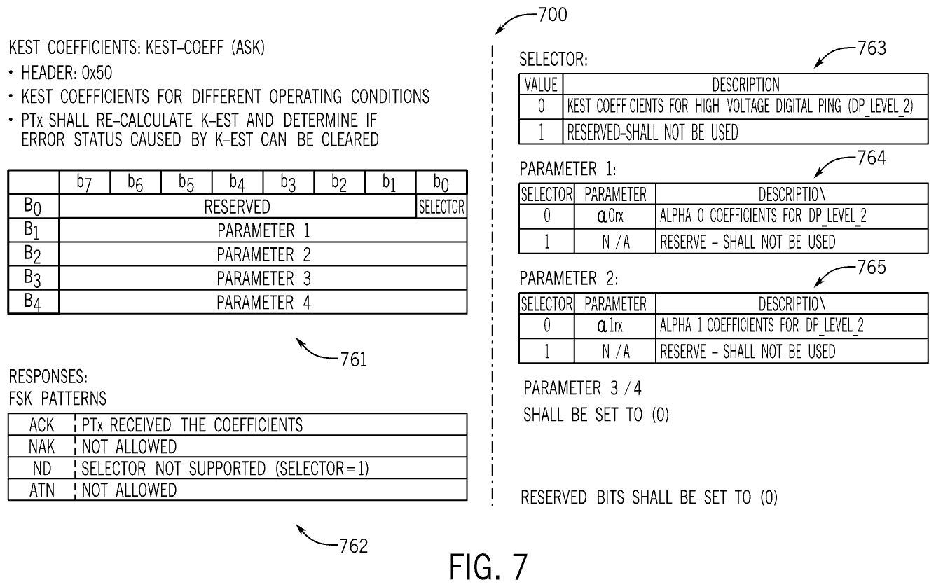

FIG. 7 illustrates an example data packet structure 700 for exchanging ecosystem scaling coefficients between a PTx and a PRx. The data packet structure may be used in conjunction with a version of the Qi standard or may be used in connection with a proprietary wireless power transfer protocol. In one embodiment, the packet 761 can include five bytes (B0-B4), each comprising eight bits (b0-b7). One or more bits (e.g., bits b1-b7 of byte B0) may be reserved for other purposes and/or future use. One bit (e.g., bit b0 of byte B0) may be used as a selector bit. As denoted in table 763, a selector bit value of 0 may be used to indicate that the packet includes k-estimation coefficients for a high voltage digital ping, and a selector bit value of zero may be a reserved/not allowed value.

One byte (e.g., byte B1) of the packet 761 can be used to provide a first ecosystem scaling parameter (e.g., alpha0), and another byte (e.g., byte B2) of the packet 761 can be used to provide a second ecosystem scaling parameter (e.g., alpha 1). As denoted in tables 764 and 765, the respective parameter fields of packet 761 can use seven bits to encode the respective parameters with a single bit of each byte reserved as a selector. In other cases, all eight bits could be used to encode the respective parameter. Unused and/or reserved bits of packet 761, e.g., the reserved bits of byte B0 and unused bytes B3 and B4 may be set to zero.

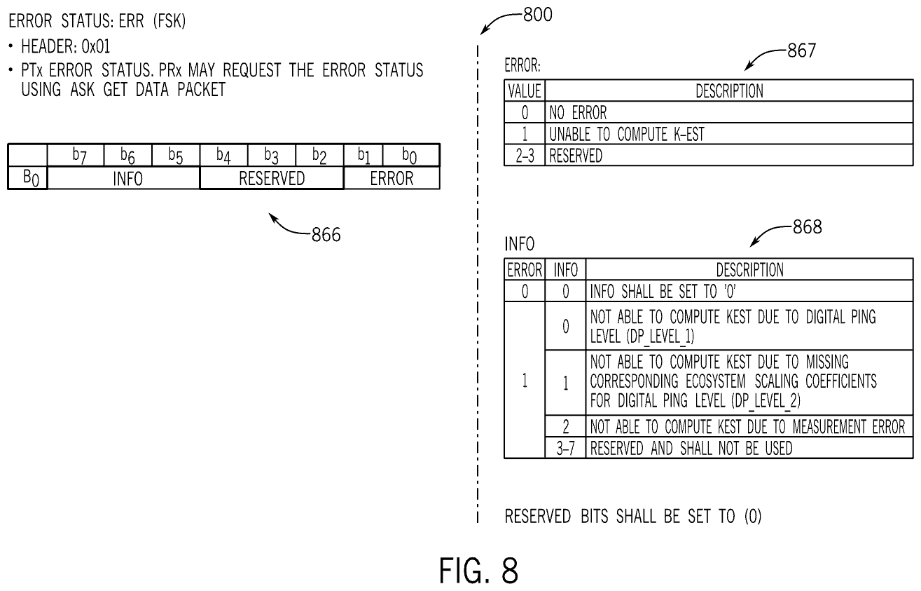

FIG. 8 illustrates an example data packet structure 800 for exchanging error information between a PTx and a PRx. The data packet structure may be used in conjunction with a version of the Qi standard or may be used in connection with a proprietary wireless power transfer protocol. In one embodiment, the packet 866 can include one byte (B0), with eight bits (b0-b7). Two bits (e.g., bits b0-b1) may be used for error indication. As denoted in table 867, a value of 0 (i.e., binary 00) for the error bits can indicate no error, and a value of 1 (i.e., binary 01) can be used to indicate an error in being unable to perform k-estimation. Other values (e.g., 2, binary 10, or 3, binary 11) can be reserved. Three bits of byte B0 of packet 866 (e.g., bits b2-b4) can be reserved, and three bits (e.g., bits b5-b7) can be used as information bits. As denoted in table 868, an info value of 0 (i.e., binary 000) can be used to indicate no error if the error value is 0 or an error that the PTx is unable to successfully perform k-estimation because of the digital ping level if the error value is 1. Likewise, an info value of 1 (i.e., binary 001) in conjunction with an error value of 1 can be used to indicate that the PTx is unable to successfully perform k-estimation because of missing ecosystem scaling coefficients. An info value of 2 (i.e., binary 010) can be used to indicate that the PTx is unable to successfully perform k-estimation because of measurement error. Info values greater than 2 (i.e., binary values 011, 100, 101, 110, and 111) can be reserved. Unused and/or reserved bits of packet 866 may be set to zero.

Described above are various features and embodiments relating to wireless power transfer techniques to address errors in a coupling coefficient estimation process conducted when initiating wireless power transfer between a PTx and a PRx. Such arrangements may be used in a variety of applications but may be particularly advantageous when used in conjunction with electronic devices such as mobile phones, tablet computers, laptop or notebook computers, and accessories such as wireless headphones, styluses, smart watches, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A method of handling k-estimation errors in a wireless power transfer system including a wireless power transmitter and a wireless power receiver, the method performed by the wireless power transmitter and comprising:
performing k-estimation during a digital ping phase of a wireless power transfer negotiation;
determining that an error occurred while performing k-estimation;
determining whether the wireless power receiver is available to assist in correcting the error;
responsive to determining that an error occurred while performing k-estimation and the wireless power receiver being available to assist in correcting the error, performing a full mode error correction procedure in which the wireless power transmitter cooperates with the wireless power receiver to correct the error that occurred during k-estimation; and
responsive to determining that an error occurred while performing k-estimation and the wireless power receiver being unavailable to assist in correcting the error, performing a restricted mode error correction procedure in which the wireless power transmitter attempts to correct the error that occurred during the k-estimation without cooperation from the wireless power receiver.

2. The method of claim 1 wherein determining that an error occurred while performing k-estimation is based on the wireless power receiver sending an extended identification packet with a restricted field therein set to 1 for restricted mode.

3. The method of claim 1 wherein performing a restricted mode error correction procedure further comprises:
removing the power signal, resetting the wireless power link;
performing one or more corrective actions; and
initiating a further digital ping phase.

4. The method of claim 3 wherein the one or more corrective actions include initiating a further digital ping at a second voltage level different from a first voltage level of the digital ping.

5. The method of claim 1 wherein performing a full mode error correction procedure further comprises:
entering a negotiation phase with error; and
communicating the error to the wireless power receiver.

6. The method of claim 5 wherein communicating the error to the wireless power receiver comprises:
sending a not acknowledged (NAK) packet responsive to a configuration (CFG) packet from the PRx;
sending an error (ERR) packet responsive to a GET packet from the wireless power receiver.

7. The method of claim 5 wherein performing a full mode error correction procedure further comprises:
responsive to receiving from the wireless power receiver, information allowing the error to be cleared, completing the wireless power transfer negotiation phase; and
responsive to not receiving, from the wireless power receiver, information allowing the error to be cleared:
receiving a request from the wireless power receiver to exit the negotiation phase;
removing the power signal, resetting the wireless power link;
performing one or more corrective actions; and
initiating a further digital ping phase.

8. The method of claim 7 wherein additional information received from the wireless power receiver includes ecosystem scaling coefficients.

9. The method of claim 8 wherein the ecosystem scaling coefficients are received in an ecosystem scaling coefficient packet.

10. The method of claim 7 wherein the information allowing the error to be cleared is included in an EPT/rst packet from the wireless power receiver.

11. A wireless power transmitter comprising control and communication circuitry that:
performs k-estimation during a digital ping phase of a wireless power transfer negotiation;
determines that an error occurred while performing k-estimation;
determines whether the wireless power receiver is available to assist in correcting the error;
responsive to determining that an error occurred while performing k-estimation and the wireless power receiver being available to assist in correcting the error, performs a full mode error correction procedure in which the wireless power transmitter cooperates with the wireless power receiver to correct the error that occurred during k-estimation, the full mode error correction procedure comprising:
entering a negotiation phase with error; and
communicating the error to the wireless power receiver; and
responsive to determining that an error occurred while performing k-estimation and the wireless power receiver being unavailable to assist in correcting the error, performs a restricted mode error correction procedure in which the wireless power transmitter attempts to correct the error that occurred during the k-estimation without cooperation from the wireless power receiver, the restricted mode error correction procedure comprising:
removing the power signal, resetting the wireless power link;
performing one or more corrective actions; and
initiating a further digital ping phase.

12. The wireless power transmitter of claim 11 wherein determining that an error occurred while performing k-estimation is based on receiving from a wireless power receiver an extended identification packet with a restricted field therein set to 1 for restricted mode.

13. The wireless power transmitter of claim 11 wherein the one or more corrective actions include the control and communication circuitry initiating a further digital ping at a second voltage level different from a first voltage level of the digital ping.

14. The wireless power transmitter of claim 11 wherein communicating the error to the wireless power receiver includes the control and communication circuitry:
sending a not acknowledged (NAK) packet responsive to a configuration (CFG) packet from the PRx;
sending an error (ERR) packet responsive to a GET packet from the wireless power receiver.

15. The wireless power transmitter of claim 11 wherein performing a full mode error correction procedure further comprises:
responsive to receiving from the wireless power receiver, information allowing the error to be cleared, completing the wireless power transfer negotiation phase, wherein the information allowing the error to be cleared is included in an EPT/rst packet from the wireless power receiver received by the control and communication circuitry; and
responsive to not receiving, from the wireless power receiver, information allowing the error to be cleared:
receiving a request from the wireless power receiver to exit the negotiation phase;
removing the power signal, resetting the wireless power link;
performing one or more corrective actions; and
initiating a further digital ping phase.

16. The wireless power transmitter of claim 15 wherein additional information received from the wireless power receiver includes ecosystem scaling coefficients received in an ecosystem scaling coefficient packet.

17. A method of handling k-estimation errors in a wireless power transfer system including a wireless power transmitter and a wireless power receiver, the method performed by the wireless power receiver and comprising:
receiving from the wireless power transmitter an indication that an error has occurred during a digital ping phase;
receiving from the wireless power transmitter an indicated cause of the error in the digital ping phase;
responsive to the indicated cause being k-estimation error and correctable by the wireless power receiver, transmitting additional information to the wireless power transmitter, thereby cooperating with the wireless power transmitter to resolve the error; and
responsive to the indicated cause not being correctable by the wireless power receiver, transmitting a reset message to the wireless power transmitter, thereby causing the wireless power transmitter to attempt to resolve the error on its own.

18. The method of claim 17 the additional information includes an extended identification packet with a restricted field therein set to 1 for restricted mode.

19. The method of claim 17 wherein transmitting additional information to the wireless power transmitter, thereby cooperating with the wireless power transmitter to resolve the error, includes transmitting ecosystem scaling coefficients in an ecosystem scaling coefficient packet.

20. The method of claim 17 wherein the reset message includes an EPT/rst packet.

21. A wireless power receiver comprising control and communication circuitry that:
receives from the wireless power transmitter an indication that an error has occurred during a digital ping phase;
receives from the wireless power transmitter an indicated cause of the error in the digital ping phase;
responsive to the indicated cause being k-estimation error and correctable by the wireless power receiver, transmits additional information to the wireless power transmitter, thereby cooperating with the wireless power transmitter to resolve the error; and
responsive to the indicated cause not being correctable by the wireless power receiver, transmits a reset message to the wireless power transmitter, thereby causing the wireless power transmitter to attempt to resolve the error on its own.

22. The wireless power receiver of claim 21 wherein the additional information includes an extended identification packet with a restricted field therein set to 1 for restricted mode.

23. The wireless power receiver of claim 21 wherein the additional information includes transmitting ecosystem scaling coefficients in an ecosystem scaling coefficient packet.

24. The wireless power receiver of claim 21 wherein the reset message includes an EPT/rst packet.
